(19) United States
(12) Patent Application Publication
(10) Pub. No.: US 2025/0074466 A1
(43) Pub. Date: Mar. 6, 2025

(54) AUTONOMOUS NAVIGATION IN THE ABSENCE OF NETWORK CONNECTIVITY VIA ANCHOR POINTS

(71) Applicant: INTERNATIONAL BUSINESS MACHINES CORPORATION, Armonk, NY (US)

(72) Inventors: Alecio Pedro Delazari Binotto, Munich (DE); SANDEEP RAMESH KHAIRNAR, PUNE (IN); Sanjay Bhaskara Panikkar, Bangalore (IN); Nir Rozenbaum, Yoqneam Illit (IL)

(21) Appl. No.: 18/459,487

(22) Filed: Sep. 1, 2023

(51) Int. Cl. B60W 60/00; G06V 20/56

(52) U.S. Cl. CPC B60W 60/0015; G06V 20/56; B60W 2420/403; B60W 2556/50

(57) ABSTRACT

Provided are a method, system, and computer program product in which a computational device of an autonomous vehicle generates a spatial awareness of an environment of the autonomous vehicle and builds local networks based on the spatial awareness to extend a navigation ability during a journey of the autonomous vehicle in an event of a loss of connectivity during navigation.

### BACKGROUND

Embodiments relate to a method, system, and computer program product for autonomous navigation in the absence of network connectivity via anchor points.

Autonomous vehicles may include automobiles, airborne vehicles, and marine vehicles that employ computer technologies to remove the need for a human operator.

Various types of sensors like camera, augmented reality camera, radar, ultrasonic sensors, etc., may be used by autonomous vehicles to automatically navigate an environment.

Autonomous vehicles may fly over terrain from one location to another. Sometimes the autonomous vehicles are assisted by connection to a network that may include a global positioning system (GPS), a wireless network, etc.

### SUMMARY

Provided are a method, system, and computer program product in which a computational device of an autonomous vehicle generates a spatial awareness of an environment of the autonomous vehicle and builds local networks based on the spatial awareness to extend a navigation ability during a journey of the autonomous vehicle in an event of a loss of connectivity during navigation.

In additional embodiments, operations are performed for including a forward path and decommissioning the spatial awareness of an area during a return path on the area.

In further embodiments, the spatial awareness is performed via recognition of objects by using an environmental camera including an Augmented Reality (AR) camera, Artificial intelligence-based models, and by continuously computing spatial location with reference to starting points and making the starting points virtual anchor points that support autonomous vehicle awareness and triangulation to support paths and return to an initial starting point. Other types of cameras besides an AR camera may be used in certain embodiments.

In certain embodiments, the virtual anchor points created along a path are continuously augmented with new information of surrounding environment during a forward journey of the autonomous vehicle for further navigational assistance, such as with augmented reality recognition.

In additional embodiments, operations are performed to dynamically build a digital twin of an environment and synchronization is performed with a control center to facilitate navigation and a replanning of a mission by a control center in the event of the loss of connectivity.

In further embodiments, in response to loss of a sensor of the autonomous vehicle during navigation such that the autonomous vehicle cannot navigate back to safety, the autonomous vehicle uses information stored about the virtual anchor points in a stack in order to return to safety.

In certain embodiments, the virtual anchor points are broadcast to a plurality of autonomous vehicles of a group so that an environment is collectively mapped, and autonomous navigation ability is enhanced by the virtual anchor points, and additionally synchronization with server control is performed.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a block diagram that shows a potential navigation scenario for an autonomous vehicle, in accordance with certain embodiments.

FIG. 3 illustrates a block diagram that shows the placement of virtual beacons during navigation, in accordance with certain embodiments.

FIG. 4 illustrates a block diagram that shows forward and return paths, in accordance with certain embodiments.

FIG. 5 illustrates a flowchart for autonomous navigation, in accordance with certain embodiments.

FIG. 6 illustrates a flowchart for autonomous navigation, in accordance with certain embodiments.

FIG. 7 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized, and structural and operational changes may be made.

During autonomous vehicle navigation, there is a need to autonomously track areas characterized by narrow aisles, and terrain sections such as underground mines, pipelines, etc. It is difficult for an autonomous vehicle to access hazardous areas for performing inspection on a periodic basis. Furthermore, in certain situations, during autonomous vehicle navigation, permanent network connectivity may be absent or may not be feasible and this may increase the difficulty of navigation.

Certain embodiments provide mechanisms to dynamically navigate without network connectivity using virtual breadcrumbs (referred to as virtual anchor points or beacons) during forward journey of a robot or an autonomous vehicle (e.g., an aerial, a marine, or a terrestrial vehicle) and decommission the network during return path. The virtual anchor points, virtual breadcrumbs, or beacons are location markers used for navigation.

Existing art discusses optimal placement of beacons, drone delivery systems, and network extension by other means. Unlike the prior art, certain embodiments provide additional capabilities by performing a network coverage extension method for autonomous vehicle navigation in the absence of network connectivity by dynamically placing virtual anchor points. As a result, improvements are made to computational devices that perform processes for autonomous vehicle navigation.

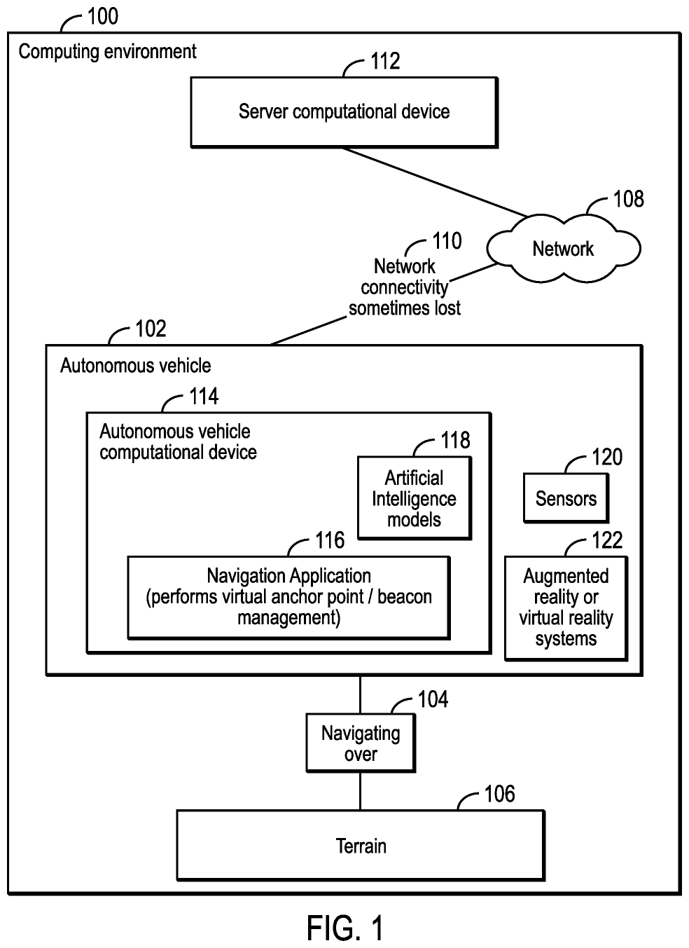

FIG. 1 illustrates a block diagram of a computing environment 100, in accordance with certain embodiments.

An autonomous vehicle 102 is shown navigating over (reference numeral 104) a terrain 106. The autonomous vehicle 102 may be communicatively coupled to a network 108, where the network connectivity may potentially be lost at times (as shown via reference numeral 110).

A server computational device 112 may also be coupled to the network 108. The autonomous vehicle 102 may include an autonomous vehicle computational device 114 in which a navigation application 116 is executed. The server computational device 112 and the autonomous vehicle computational device 114 may include any suitable computational device with a processor that is known in the art. The network 108 may include the Internet, a global positioning system (GPS) network, or any other network known in the art.

In certain embodiments, the autonomous vehicle computational device 114 may include artificial intelligence models 118 used by the navigation application 116. Sensors 120 (e.g., camera and other imaging devices, etc.) and augmented reality or virtual reality systems 122 may be included in the autonomous vehicle and used for navigation.

The navigation application 116 performs anchor point management by storing anchor points (also referred to as breadcrumbs or beacons) during navigation when the network connectivity is lost. These anchor points may be used to retrace paths for the autonomous vehicle and perform other functions.

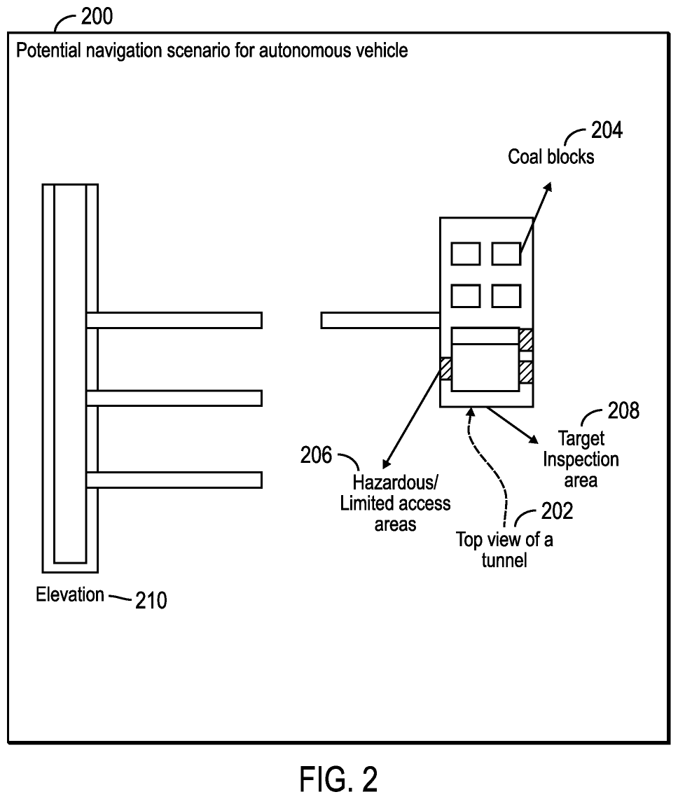

FIG. 2 illustrates a block diagram 200 that shows a potential navigation scenario for an autonomous vehicle, in accordance with certain embodiments.

An autonomous vehicle may have to navigate through various types of areas. In FIG. 2, an exemplary top view of a tunnel 202 through which the autonomous vehicle navigates is shown. Various areas such as coal blocks 204 of mines, hazardous or limited access areas 206 and target inspection areas 208 are shown in the top view.

The elevation 210 at various parts of the terrain are also shown in FIG. 2. The autonomous vehicle may have to navigate through a scenario like the one shown in FIG. 2.

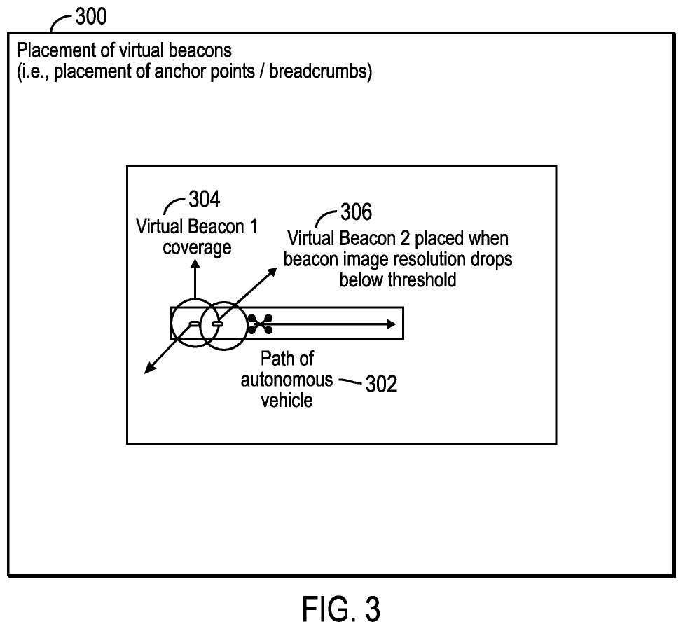

FIG. 3 illustrates a block diagram 300 that shows the placement of virtual beacons (i.e., virtual anchor points) during navigation, in accordance with certain embodiments.

Certain embodiments provide a virtual breadcrumbs-based (i.e., anchor or beacon based) approach to explorative navigation without network coverage. Autonomous vehicles equipped with high resolution cameras with Augmented reality (AR), or Virtual reality (VR) capabilities and AR/VR software are capable of dropping and viewing virtual beacons (breadcrumbs/anchors) along a path.

The AR/VR software keeps track of dimensions of virtual beacons as an unmanned aerial vehicle (UAV) or an unmanned ground vehicle (UGV) moves forward and also detects obstacles to virtual beacon if identified from AR/VR camera during the movement. Further the software keeps track of angle, direction, elevation parameters from previous reference virtual beacon to determine the visibility of virtual beacon during the progression.

Certain embodiments dynamically calculate distance, and/or directional angle from a virtual beacon of fixed height and dimensions dropped using camera, AR/VR software and edge algorithm to determine need for new virtual breadcrumb placements along an UAV/AGV path. As the vehicle moves, the camera recalibrates the dimension (example height) of the virtual breadcrumb and continuously stores this information on the edge.

Certain embodiments add new virtual breadcrumbs to the network when the dimension of last beacon drops below threshold or line of sight (LoS) to last beacon diminishes as calculated via an edge algorithm. The term beacon is used to denote the current anchor point or breadcrumb that is fixated on while navigating. If the beacon is in danger of disappearing from view, then a new virtual anchor point or breadcrumb is placed, and this becomes the new beacon.

Certain embodiments continuously augment prior beacon with information of relevant surrounding beacons as they are placed, so that AR/VR Camera can render and use these insights (of surroundings beacons) when they are at a specific beacon anytime later.

If during a flight path, the camera recognizes a distinct physical object in the route (e.g., a tunnel branch), the process drops a special virtual breadcrumb with information of physical characteristics identified (such as width of tunnel branch, height).

The process creates a numbered lookup table of the sequence of virtual breadcrumbs dropped, with the data in the edge (i.e., locally stored).

FIG. 3 shows the path 302 traversed by an autonomous vehicle. The coverage area of a virtual beacon 1 is shown via reference numeral 304. Reference numeral 306 shows that a virtual beacon 2 is placed when the current beacon image resolution drops below a threshold level. So, a virtual beacon 1 disappears from view, a virtual beacon 2 is placed.

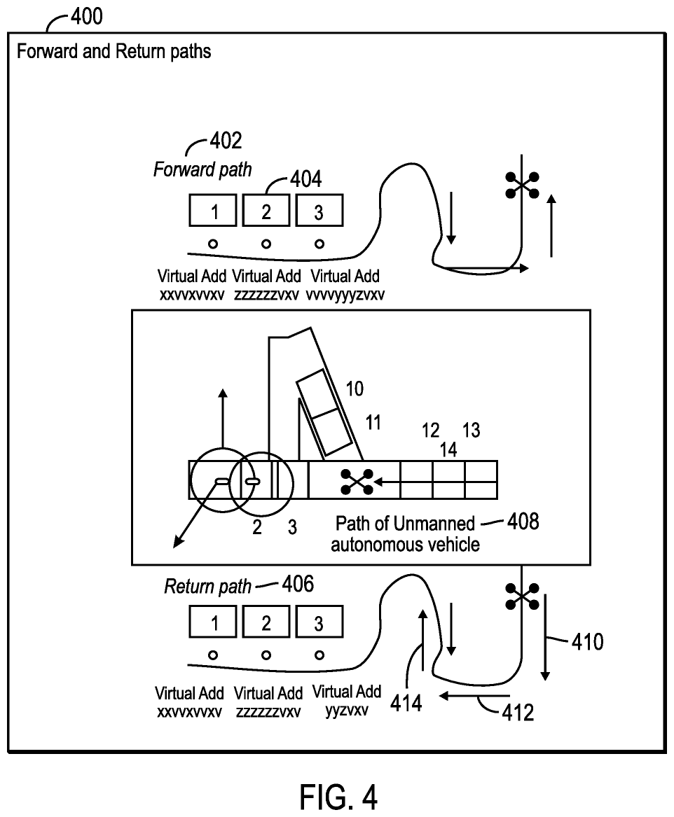

FIG. 4 illustrates a block diagram 400 that shows a forward path 402 and a return path 406, in accordance with certain embodiments.

The process creates the path during the autonomous navigation by connecting the numbered nodes (virtual breadcrumbs) with accurate angles of forward path (in three-dimensional x, y, z coordinates).

The return journey may retrace the path based on a look up table, numbered breadcrumbs, and angles captured in the forward route. Virtual breadcrumbs are marked as “crossed” to mark as navigated path in the return journey as the vehicles crosses them.

Vehicle paths are decided based on grids created by using the locations of virtual breadcrumbs and by positioning autonomously during forward and return journey respectively. Dynamic map construction of the constrained space in a vehicle can then be merged to create master maps that are used to enable updates or revisions.

Certain embodiments update digital twins in edge to create a knowledge graph of the area (e.g., underground mine) being explored using reconstructed maps merged with original, real-time sensor values (e.g., gas concentration levels such as methane or hazardous area footprint). Certain embodiments support future missions based on past missions-capturing in a graph, the obstacles, environment conditions, path, mission goal, virtual breadcrumb's location, etc.

Certain embodiments build simulations (for future missions) of the explored section using digital twins. For example, a determination may be made as to under what operating and environment conditions a section can become safe for use for business purposes. Additionally, conditions under which a section needs to be permanently blocked may be determined. Sustainability calculations such as the Carbon footprint or methane emissions levels may be determined by using extrapolations from the explored section.

A combination of technologies can be used for Virtual breadcrumbs by using AR/VR software, High resolution cameras, Real Time Edge Analytics, Digital Twins, etc.

In FIG. 4, in the forward path the virtual beacons 1, 2, 3 are shown via reference numeral 404. An exemplary path 408 of the unmanned autonomous vehicle is shown with virtual breadcrumbs that have been numbered up to 14.

During the return path 406 the path that was stored is retraced in reverse as shown via reference numerals 410, 412, 414.

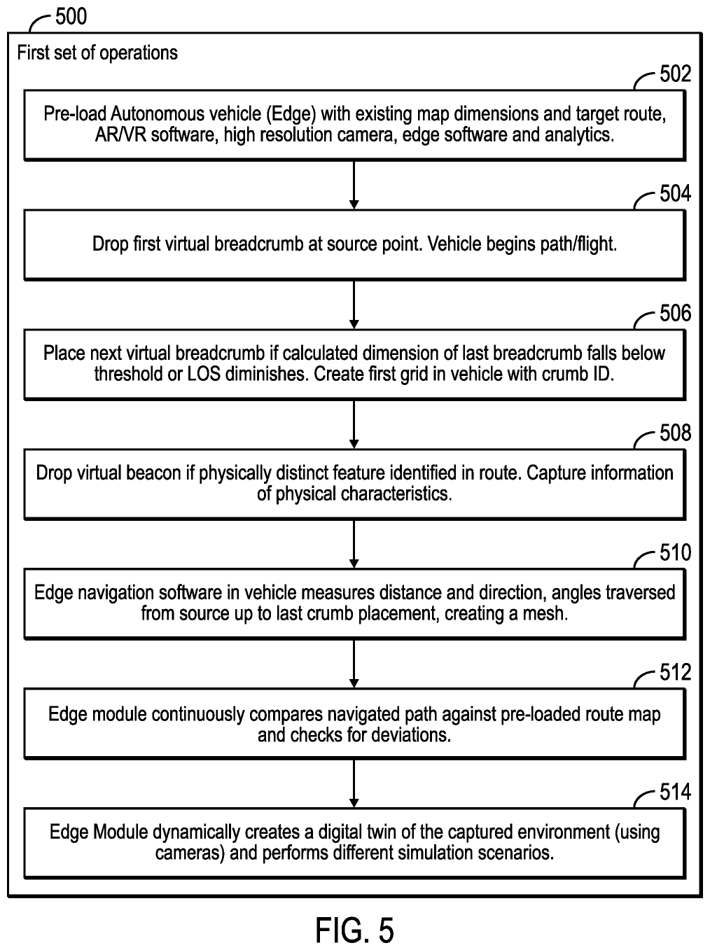

FIG. 5 illustrates a flowchart 500 for autonomous navigation, in accordance with certain embodiments. The operations shown in FIG. 5 are performed in the computing environment 100 in the sequence 1 to 7 in certain embodiments. The autonomous vehicle is said to be at the edge of the network and the software modules in the autonomous vehicle are referred to as edge modules (e.g., navigation application 116).

The operations performed in a first set of operations are as follows:
1) Pre-load autonomous vehicle (at the Edge) with existing map dimensions and target route, AR/VR software, high resolution camera, edge software and analytics (reference numeral 502).
2) Drop first virtual breadcrumb at source point. Vehicle begins path/flight (reference numeral 504).
3) Place next virtual breadcrumb if calculated dimension of last breadcrumb falls below threshold or line of sight (LOS) diminishes. Create first grid in vehicle with crumb identifier (reference numeral 506).
4) Drop virtual beacon if physically distinct feature identified in route. Capture information of physical characteristics (reference numeral 508).
5) Edge navigation software in vehicle measures distance and direction, angles traversed from source up to last crumb placement, thereby creating a mesh (reference numeral 510).
6) Edge module continuously compares navigated path against pre-loaded route map and checks for deviations (reference numeral 512).
7) Edge module dynamically creates a digital twin of the captured environment (using cameras) and performs different simulation scenarios (for example, determine “what-if”' a particular situation occurred) (reference numeral 514).

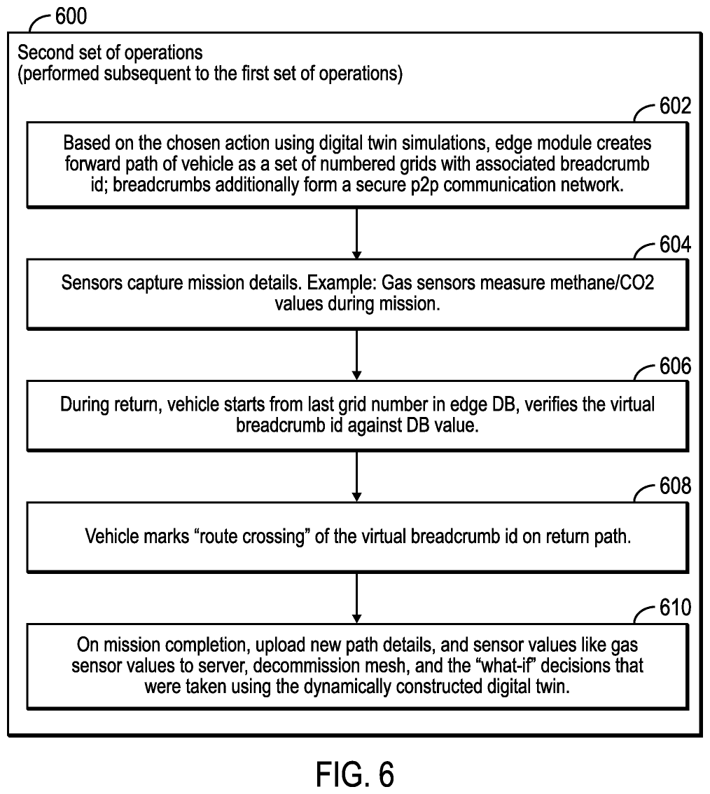

At the completion of block 514 control proceeds to block 602 of FIG. 6.

FIG. 6 illustrates a flowchart 600 for autonomous navigation, in accordance with certain embodiments. The operations shown in FIG. 6 are performed in the computing environment 100. These are shown as a second set of operations numbered 8 to 12 below as follows (the second set of operations 8-12 are performed after the first set of operations 1-7 shown in FIG. 5):
8) Based on the chosen action using digital twin simulations, edge module creates forward path of vehicle as a set of numbered grids with associated breadcrumb identifiers breadcrumbs additionally form a secure peer to peer (p2p) communication network (reference numeral 602).
9) Sensors capture mission details. For example, Gas sensors measure methane/CO2 values during mission (reference numeral 604).
10) During return, vehicle starts from last grid number in an edge database (DB), and verifies the virtual breadcrumb identifier against DB value (reference numeral 606).
11) Vehicle marks “route crossing” of the virtual breadcrumb identifier on return path (reference numeral 608).
12) On mission completion, upload new path details, and sensor values like gas sensor values to server computational device 112, decommission mesh, and the “what-if” decisions that were taken using the dynamically constructed digital twin (reference numeral 610).

In another embodiment, an autonomous vehicle (or any other robot) starts the execution of a mission and even if there is connectivity the autonomous vehicle puts virtual breadcrumbs starting from the nearest safety point relative to the beginning of the mission.

The same mechanisms from a previous embodiment can be used, where every time that the autonomous vehicle puts a virtual breadcrumb, it inserts into a stack the metadata about the virtual breadcrumb (e.g., the distance and angle from previous virtual breadcrumb).

If during the mission execution, one of the autonomous vehicle's crucial sensors is lost in a way such that the autonomous vehicle cannot navigate back to safety (e.g., object avoidance sensor is lost), the autonomous vehicle may use the information stored about the virtual breadcrumbs in the stack in order to return to safety. The autonomous vehicle will pop from stack the metadata about the virtual breadcrumbs (distance and angle) one by one, for each one will traverse it and follow the reverse path. The autonomous vehicle will continue until reaching the first virtual breadcrumb point, which is a safety landing point as mentioned, and will be able to land safely.

Therefore FIGS. 1-6 illustrate certain embodiments in which an autonomous vehicle may navigate safely even in the event network connectivity is lost.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

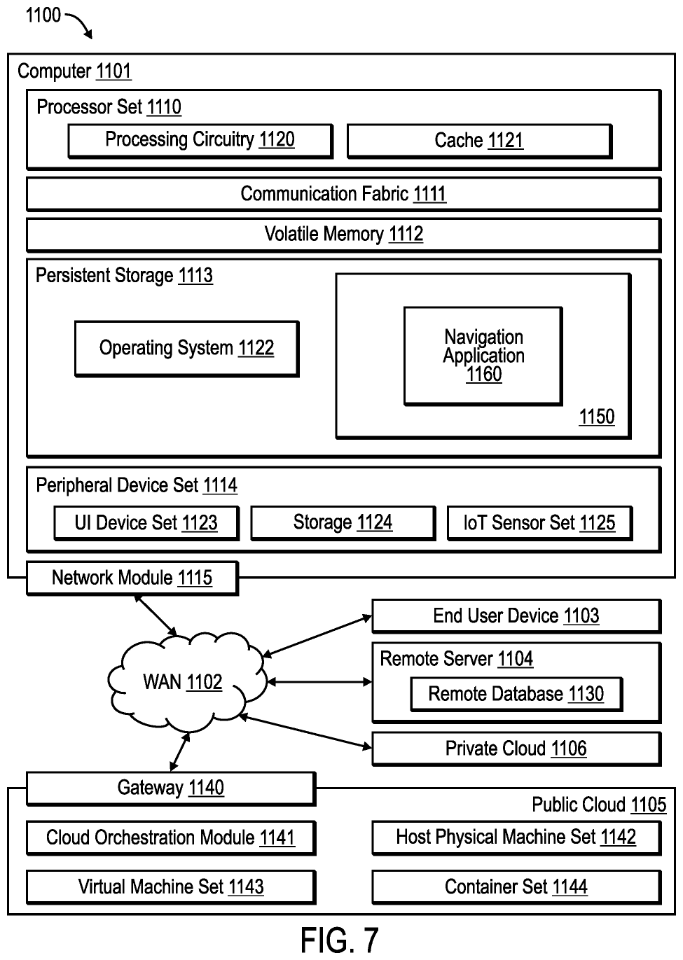

In FIG. 7, computing environment 1100 contains an example of an environment for the execution of at least some of the computer code (block 1150) involved in performing the operations of a navigation application 1160 that performs operations shown in FIGS. 1-6.

In addition to block 1150, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112. persistent storage 1113 (including operating system 1122 and block 1150, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1150 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface-type operating systems that employ a kernel. The code included in block 1150 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. I/O T sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method, comprising:
generating, via a computational device of an autonomous vehicle, a spatial awareness of an environment of the autonomous vehicle and building local networks based on the spatial awareness to extend a navigation ability during a journey of the autonomous vehicle in an event of a loss of connectivity during navigation.

2. The method of claim 1, the method further comprising:
including a forward path and decommissioning the spatial awareness of an area during a return path on the area.

3. The method of claim 1, wherein the spatial awareness is performed via recognition of objects by using an environmental camera including an Augmented Reality (AR) camera, Artificial intelligence-based models, and by continuously computing spatial location with reference to starting points and making the starting points virtual anchor points that support autonomous vehicle awareness and triangulation to support paths and return to an initial starting point.

4. The method of claim 3, wherein the virtual anchor points created along a path are continuously augmented with new information of surrounding environment during a forward journey of the autonomous vehicle for further navigational assistance.

5. The method of claim 3, the method further comprising:
dynamically building a digital twin of an environment and synchronizing with a control center to facilitate navigation and a replanning of a mission by a control center in the event of the loss of connectivity.

6. The method of claim 3, wherein in response to loss of a sensor of the autonomous vehicle during navigation such that the autonomous vehicle cannot navigate back to safety, the autonomous vehicle uses information stored about the virtual anchor points in a stack in order to return to safety.

7. The method of claim 3, wherein the virtual anchor points are broadcast to a plurality of autonomous vehicles of a group so that an environment is collectively mapped, and autonomous navigation ability is enhanced by the virtual anchor points, and additionally synchronization with server control is performed.

8. A system, comprising:
a memory; and
a processor coupled to the memory, wherein the processor performs operations, the operations comprising:
generating a spatial awareness of an environment of an autonomous vehicle and building local networks based on the spatial awareness to extend a navigation ability during a journey of the autonomous vehicle in an event of a loss of connectivity during navigation.

9. The system of claim 8, the operations further comprising:
including a forward path and decommissioning the spatial awareness of an area during a return path on the area.

10. The system of claim 8, wherein the spatial awareness is performed via recognition of objects by using an environmental camera including an Augmented Reality (AR) camera, Artificial intelligence-based models, and by continuously computing spatial location with reference to starting points and making the starting points virtual anchor points that support autonomous vehicle awareness and triangulation to support paths and return to an initial starting point.

11. The system of claim 10, wherein the virtual anchor points created along a path are continuously augmented with new information of surrounding environment during a forward journey of the autonomous vehicle for further navigational assistance.

12. The system of claim 10, the operations further comprising:
dynamically building a digital twin of an environment and synchronizing with a control center to facilitate navigation and a replanning of a mission by a control center in the event of the loss of connectivity.

13. The system of claim 10, wherein in response to loss of a sensor of the autonomous vehicle during navigation such that the autonomous vehicle cannot navigate back to safety, the autonomous vehicle uses information stored about the virtual anchor points in a stack in order to return to safety.

14. The system of claim 10, wherein the virtual anchor points are broadcast to a plurality of autonomous vehicles of a group so that an environment is collectively mapped, and autonomous navigation ability is enhanced by the virtual anchor points, and additionally synchronization with server control is performed.

15. A computer program product, the computer program product comprising a computer readable storage medium having computer readable program code embodied therewith, the computer readable program code when executed is configured to perform operations, the operations comprising:
generating, via a computational device of an autonomous vehicle, a spatial awareness of an environment of the autonomous vehicle and building local networks based on the spatial awareness to extend a navigation ability during a journey of the autonomous vehicle in an event of a loss of connectivity during navigation.

16. The computer program product of claim 15, the operations further comprising:
including a forward path and decommissioning the spatial awareness of an area during a return path on the area.

17. The computer program product of claim 15, wherein the spatial awareness is performed via recognition of objects by using an environmental camera including an Augmented Reality (AR) camera, Artificial intelligence-based models, and by continuously computing spatial location with reference to starting points and making the starting points virtual anchor points that support autonomous vehicle awareness and triangulation to support paths and return to an initial starting point.

18. The computer program product of claim 17, wherein the virtual anchor points created along a path are continuously augmented with new information of surrounding environment during a forward journey of the autonomous vehicle for further navigational assistance.

19. The computer program product of claim 17, the operations further comprising:
dynamically building a digital twin of an environment and synchronizing with a control center to facilitate navigation and a replanning of a mission by a control center in the event of the loss of connectivity.

20. The computer program product of claim 17, wherein in response to loss of a sensor of the autonomous vehicle during navigation such that the autonomous vehicle cannot navigate back to safety, the autonomous vehicle uses information stored about the virtual anchor points in a stack in order to return to safety.
